(19) United States
(12) Patent Application Publication
(10) Pub. No.: US 2016/0378652 A1
(43) Pub. Date: Dec. 29, 2016

(54) CACHE MEMORY SYSTEM AND PROCESSOR SYSTEM

(71) Applicant: KABUSHIKI KAISHA TOSHIBA, Tokyo (JP)

(72) Inventors: Susumu TAKEDA, Kawasaki (JP); Shinobu FUJITA, Tokyo (JP)

(21) Appl. No.: 15/262,178

(22) Filed: Sep. 12, 2016

Related U.S. Application Data
(63) Continuation of application No. PCT/JP2015/058417, filed on Mar. 20, 2015.

(30) Foreign Application Priority Data
Mar. 20, 2014 (JP) 2014-058817

(51) Int. Cl. G06F 12/0804; G06F 12/0811

(52) U.S. Cl. CPC G06F 12/0804; G06F 12/0811; G06F 2212/1024; G06F 2212/1041; G06F 2212/283; G06F 2212/68

(57) ABSTRACT

A cache memory system has a group of layered memories has two or more memories having different characteristics, an access information storage which stores address conversion information from a virtual address into a physical address, and stores at least one of information on access frequency or information on access restriction, for data to be accessed with an access request, and a controller to select a specific memory from the group of layered memories and perform access control, based on at least one of the information on access frequency and the information on access restriction in the access information storage, for data to be accessed with an access request from the processor, wherein the information on access restriction in the access information storage comprises at least one of read-only information, write-only information, readable and writable information, and dirty information indicating that write-back to a lower layer memory is not yet performed.

### CROSS REFERENCE TO RELATED APPLICATIONS

This application is based upon and claims the benefit of priority from the prior Japanese Patent Application No. 2014-58817, filed on Mar. 20, 2014, the entire contents of which are incorporated herein by reference.

### FIELD

Embodiments relate to a cache memory system and a processor system,

### BACKGROUND

As referred to as a memory wall problem, memory access is a bottleneck in performance and power consumption of processor cores. In order to mitigate this problem, memory capacity of cache memories has been increased.

Existing capacity cache memories generally have SRAMs (Static Random Access Memory). Although operating at high speeds, the SRAMs consume large stand-by power and have a large memory cell area, and hence it is difficult to increase a memory capacity.

Because of such a background, it has been proposed to adopt MRAMs (Magnetoresistive Random Access Memory) which consume small stand-by power and are easy to be micro-fabricated, as cache memories.

However, ordinary MRAMs have a problem that write speed is lower than a read speed and power consumption is large. In the case of using the MRAMs as cache memories, when data with a high frequency of writing are stored in the MRAMs, processing efficiency of the entire processor system may be lowered.

### BRIEF DESCRIPTION OF THE DRAWINGS

FIG. 1 is a block diagram schematically showing the configuration of a processor system 1 according to an embodiment;

FIG. 2 is a diagram showing access priority to cache memories and 7, and a main memory 10 in a first embodiment;

FIG. 3 is a diagram showing an example of the internal configuration of a TLB 4;

FIG. 4 is a block diagram of a processor system for acquiring access frequency information only on a memory of a specific layer;

FIG. 5 is a block diagram showing an example of a same-layer hybrid cache;

FIG. 6 is a flow chart showing an example of a write process in the same-layer hybrid cache;

FIG. 7 is a block diagram showing an example of a different-layer hybrid cache; and

FIG. 8 is a flow chart showing an example of a write process in the different-layer hybrid cache.

### DETAILED DESCRIPTION

According to the present embodiment, there is provided a cache memory system has:

a group of layered memories comprising two or more memories having different characteristics;

an access information storage which stores address conversion information from a virtual address included in an access request of a processor, into a physical address, and stores at least one of information on access frequency or information on access restriction, for data to be accessed with an access request from the processor; and

a controller to select a specific memory from the group of layered memories and perform access control, based on at least one of the information on access frequency and the information on access restriction in the access information storage, for data to be accessed with an access request from the processor,

wherein the information on access restriction in the access information storage comprises at least one of read-only information, write-only information, readable and writable information, and dirty information indicating that write-back to a lower layer memory is not yet performed.

Hereinafter, embodiments will be explained with reference to the drawings. The following embodiments will be explained mainly with unique configurations and operations of a cache memory system and a processor system. However, the cache memory system and the processor system may have other configurations and operations which will not be described below. These omitted configurations and operations may also be included in the scope of the embodiments.

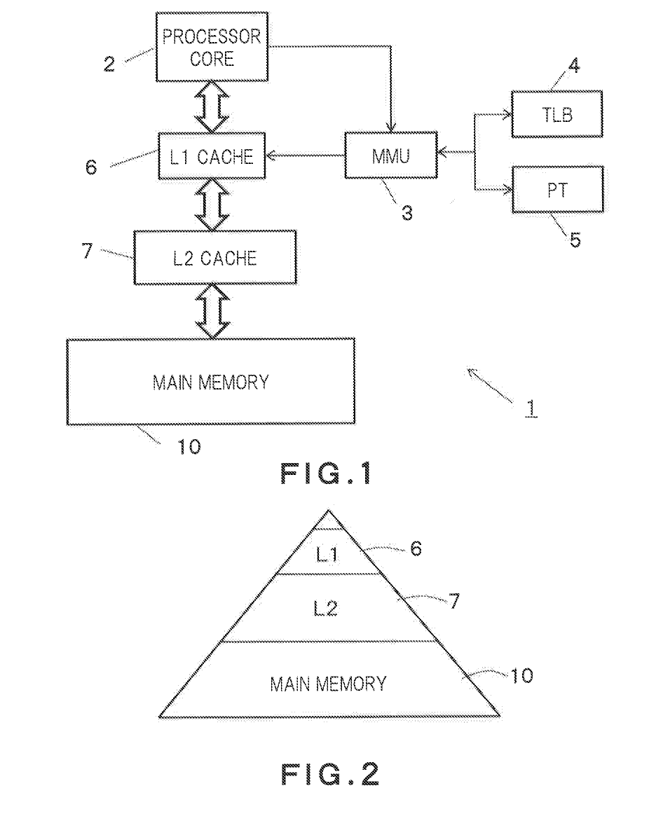

FIG. 1 is a block diagram schematically showing configuration of a processor system 1 according to an embodiment. The processor system 1 of FIG. 1 is provided with a processor (CPU: Central Processing Unit) 2, a memory management unit (MMU) 3, a translation lookaside buffer (TLB) 4, a page table (PT) 5, a first-level cache memory (L1-cache) 6, and a second-level cache memory (L2-cache) 7.

At least parts of data stored in a main memory 10 or to be stored therein are stored in the L1- and L2-caches 6 and 7. The caches 6 and 7 have tag storing address information with which data stored in the caches are identifiable. There is a variety of configurations for the tag to store the address information. For example, the tag may have dedicated memory areas or may store the address information in a part of data memory areas. The present embodiment can be combined with all of these configurations.

FIG. 1 shows an example of cache memories in two layers up to the L2-cache 7. Cache memories of higher level than the L2-cache 7 may also be provided. Namely, in the present embodiment, it is a precondition that two or more memories having different characteristics are provided in different layers or two or more memories having different characteristics are provided in one and the same layer. One characteristic is, for example, an access speed. Other characteristics may be power consumption, capacity or any other factors that distinguish between the memories,

In the following, an example of cache configuration in two layers up to the L2-cache 7 will be explained,

The processor 2, the MMU 3, the L1-cache 6, and the L2-cache 7, other than the main memory 10, are, for example, integrated in one chip. For example, a system may be structured in the following manner. The processor 2, the MMU 3, and the L1-cache 6 are integrated into one chip. The L2-cache 7 is integrated into another chip. The chips are directly joined to each other by metal wirings based on the chips' integrated structures. In the present embodiment, a system having the MMU 3 and the L1- and L2-caches 6 and 7 is referred to as a cache memory system. The main memory 10. TLB 4 and page table 5 which will be described later may also be or may not be included in the cache memory system,

The L1- and L2-caches 6 and 7 have semiconductor memories accessible at higher speeds than the main memory 10. There are variations in policy of data allocation to the caches. One mode is, for example, an inclusion type. In this case, all of data stored in the L1-cache 6 are stored in the L2-cache 7.

Another mode is, for example, an exclusion type. In this mode, the same data is not allocated for example, to the L1-cache 6 and the L2-cache 7. A further mode is a hybrid mode of, for example, the inclusion type and the exclusion type. In this mode, there are duplicate data stored, for example, in the L1-cache 6 and the L2-cache 7, and also there are data exclusively stored therein.

These modes are a policy of data allocation between the L1- and L2-caches 6 and 7. There is a variety of combinations in a multi-layered cache configuration. For example, the inclusion type may be used in all layers. For example, Exclusive may be used in the L1- and L2-caches 6 and 7, and the inclusion type may be used in the L2-cache 7 and the main memory 10. In the method of the present embodiment, a variety of data allocation policies listed above may be combined.

There is a variety of cache updating methods. Any one of them can be combined into the present embodiment. For example, write-through or write-back may be used in writing to a cache in the case of a write hit in the cache. For example, write-allocate or no-write-allocate may be used in writing to a cache in the case of a write miss in the cache.

The L2-cache 7 has a memory capacity equal to or larger than that of the L1-cache 6. Accordingly, higher-level cache memories have a larger memory capacity. It is therefore desirable, for higher-level cache memories, to use a highly-integrated memory having a smaller leakage power which tends to be in proportion to the memory capacity. One type of such memory is, for example, a non-volatile memory such as an MRAM (Magnetoresistive Random Access Memory). An SRAM or DRAM using a low leakage power process may also be used.

The page table 5 stores mapped OS-managed virtual-address and physical-address spaces. In general, virtual addresses are used as an index. The page table 5 has an area for storing physical addresses corresponding to respective virtual addresses, and the like. An area in the page table 5, which corresponds to one virtual address, is referred to as a page entry. The page table 5 is generally allocated in the main memory space.

The TLB 4 is a memory area for caching a part of the page entries in the page table 5. The TLB 4 is generally installed in the form of hardware, which is accessible at a higher speed than a page table installed in the form of software.

The MMU 3 manages the TLB 4 and the page table 5, with a variety of functions, such as, an address conversion function (virtual storage management) to convert a virtual address issued by the processor 2 to a physical address, a memory protection function, a cache control function, a bus arbitration function, etc. Upper-layer caches such as the L1-cache 6 may be accessed with a virtual address. In general, lower-layer caches such as the L2-cache 7 and the further lower-layer caches are accessed with a physical address converted by the MMU 3. The MMU 3 updates a virtual-physical address conversion table in the case of data allocation to the main memory 10 and data flush out from the main memory 10. The MMU 3 can be configured in a variety of form, such as, in the form of hardware entirely, software entirely or a hybrid of hardware and software. Any of the forms can be used in the present embodiment.

In FIG. 1, the TLB 4 is provided apart from the MMU 3. However, the TLB 4 is generally built in the MMU 3. Although in the present embodiment, the MMU 3 and the TLB 4 are treated apart from each other, the TLB 4 may be built in the MMU 3.

The main memory 10 has a larger memory capacity than the L1 and L2-caches 6 and 7. Therefore, the main memory 10 is mostly built in one or more chips apart from a chip in which the processor 2 and the like are built, Memory cells of the main memory 10 are, for example, DRAM (Dynamic RAM) cells. The memory cells may be built in one chip with the processor 2 and the like by the technique of TSV (Through Silicon Via) or the like.

FIG. 2 is diagram showing access priority to the cache memories 6 and 7, and the main memory 10 in a first embodiment. As shown, a physical address corresponding to a virtual address issued by the processor 2 is sent to the L1-cache 6 at a top priority. If data (hereinafter, target data) corresponding to the physical address is present in the L1-cache 6, the data is accessed by the processor 2. The L1-cache 6 has a memory capacity of, for example, about several 10 bytes.

If the target data is not present in the L1-cache 6, the corresponding physical address is sent to the L2-cache 7. If the target data is present in the L2-cache 7, the data is accessed by the processor 2. The L2-cache 7 has a memory capacity of, for example, about several 100 kilobytes to several megabytes.

If the target data is not present in the L2-cache 7, the corresponding physical address is sent to the main memory 10. It is a precondition in the present embodiment that all data stored in the L2-cache 7 have been stored in the main memory 10. The present embodiment is not limited to the in-between-caches data allocation policy described above. Data stored in the main memory 10 are per-page data managed by the MMU 3. In general, per-page data managed by the MMU 3 are allocated in the main memory 10 and an auxiliary memory device. However, in the present embodiment, all of those data are allocated in the main memory 10, for convenience. In the present embodiment, if the target data is present in the main memory 10, the data is accessed by the processor 2. The main memory 10 has a memory capacity of, for example, about several gigabytes.

As described above, the L1- and L2-caches 6 and 7 are layered. A higher-level (lower-layer) cache memory has a larger memory capacity. In the present embodiment, all data stored in a lower-level (upper-layer) cache memory are stored in a higher-level cache memory, for simplicity.

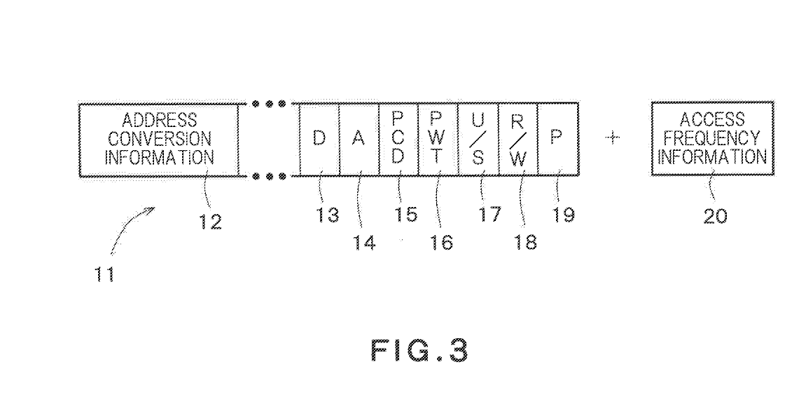

FIG. 3 is a diagram showing an example of the internal configuration of the TLB 4. The TLB 4 manages several types of information in pages. Here, one page is data of four kilobytes, for example.

FIG. 3 shows an example of page entry information 11 for one page. The page entry information 11 of FIG. 3 has address conversion information 12, a dirty bit 13, an access bit 14, a page-cache disable bit 15, a page write-through bit 16, a user supervisor bit 17, a read/write bit (read/write information) 18, and a presence bit 19. In addition, the page entry information 11 has access frequency information 20.

The order of the several types of information allocated in the page entry information 11 shown in FIG. 3 is just an example. The present embodiment is not limited to this order. It is supposed that the present embodiment is applied to an existing processor 2, in other words, in the case of adding the access frequency information 20 to an existing page table 5. In this case, there is a method of storing the access frequency information 20 in an empty area of an existing page entry information 11 and a method of extending a bit width of the existing page entry information 11.

There are three options for the page entry information 11 that includes the access frequency information 20 to be stored. One option is that the page entry information 11 is stored in the TLB 4 only. Another option is that the page entry information 11 is stored in the page table 5 only. Still another option is that the page entry information 11 is stored in both of the TLB 4 and the page table 5. Any of the three options can be combined with either of the above method of adding the access frequency information 20 to the existing the page entry information 11 or the method of extending a bit width of the existing page entry information 11. In the present embodiment, the TLB 4 and the page table 5 which store the access frequency information 20 are referred to as an access information storage unit, as a general term.

In the case of storing the access frequency information 20 in both of the TLB 4 and the page table 5, it is preferable that the page table 5 has page entry information 11 having the same internal configuration as shown in FIG. 3. The TLB 4 stores address conversion information on a virtual address recently issued by the processor 2. On the other hand, the page table 5 stores address conversion information on the entire main memory 10. Therefore, even if the TLB 4 has no page entry information 11 on a virtual address issued by the processor 2, the access frequency information 20 stored in the corresponding page entry information 11 can be acquired by looking up to the page table 5. When flushing out at least a part of the page entry information 11 in the TLB 4, it is preferable to write-back the page entry information 11 to be flushed out and the corresponding access frequency information 20, to the page table 5. In this way, the page table 5 can store cache presence information 20 corresponding to the page entry information 11 that cannot be stored in the TLB 4.

One example explained in the present embodiment is that both of the TLB 4 and the page table 5 store the page entry information 11 shown in FIG. 3 and the access frequency information 20 is included in the page entry information 11. It is also supposed that the existing page entry has an enough empty area for adding the access frequency information 20.

The address conversion information 12 in the page entry information 11 shown in FIG. 3 is information for converting a virtual address issued by the processor 2 into a physical address. The address conversion information 12 is, for example, a physical address corresponding to a logical address, a pointer to the page table 5 having a layered configuration, etc. The dirty bit 13 is set to 1 when writing is made to a page in the page table 5. The access bit 14 is set to 1 when access is made to this page. The page cache disable bit 15 is set to 1 when caching to this page is inhibited. The page write-through bit 16 is set to 0 when write-through is made and to 1 when write-back is made. The write-through is defined to write data in both of a cache memory and the main memory 10. The write-back is defined to write data in a cache memory and then write the data back to the main memory 10. The user supervisor bit 17 sets a user mode or a supervisor mode for use of the page mentioned above. The read/write bit 18 corresponding to the read/write information is set to 1 when writing is permitted and to 0 in other cases. The presence bit 19 is set to 1 when the page mentioned above is present in the main memory 10. These types of information are not limited to those used in the above example, in the same way as those types of information having a variety of forms in the marketed CPUs.

The access frequency information 20 is memory access information per unit of time, which is, for example, the number of times of accessing per unit of time, the number of times of missing per unit of time, etc. In more specifically, the access frequency information 20 is, for example, information (W/R information) on whether reading or writing occurs more often per unit of time, information (cache hit/miss information) on whether cache hit or cache miss occurs more often per unit of time, etc. The writing mentioned above means data update by the CPU 2, which may include writing by replacement of data stored in a cache. In the present embodiment, writing means data update by the CPU 2, for simplicity.

There is no particular limitation on a practical data format of the access frequency information 20. For example, when the access frequency information 20 is the W/R information, a saturation counter is provided to count addresses accessed by the processor 20 per page, which is then counted up when accessing is writing and counted down when accessing is reading. The access frequency information 20 in this case is the count value of the saturation counter. It is found that if the count value is a large value, it means that data is to be written at a high frequency of writing. The saturation counter may be built in the MMU 3. By the count value of the saturation counter, the MMU 3 can quickly determine whether data is to be written at a high frequency of writing.

For example, when the access frequency information 20 is the cache hit/miss information, a saturation counter is provided to count cache hits/misses, which is then counted up when accessing is a cache miss and counted down when accessing is a cache hit. It is found that if the count value is a large value, it means that data is cache missed often. In addition to the saturation counter, cache access times may be stored to give information on a ratio of the frequency of cache miss to the total access.

The above-described types of information may, not only be stored in pages, but also stored in a variety of ways. For example, the information may be stored per line in a page. For example, in the case of a 4-kbyte page size with a 64-byte line size, since each page has 64 lines, 64 areas may be provided to store the information per line for each entry of the TLB 4 or the page table 5. Moreover, as a way to store the information per line for each page, per-line information may be hashed to be stored per page. Or each piece of the information may be stored for a plurality of lines which are smaller than each page. The example shown in the present embodiment is to store the information in pages, for simplicity,

The several types of information other than the access frequency information 20 in the page entry information 11 of the TLB 4 or page table 5 are referred to as access restriction information in the present embodiment. The access frequency information 20 is generated by the MMU 3 in accordance with an access request by the processor 2 or access information to a cache memory.

One feature of the present embodiment is that the MMU 3 selects a memory to be accessed among memories of plural layers based on at least one of the access restriction information and the access frequency information 20 in the page entry information 11. In other words, the MMU 3 functions as a provider of information to be used in selection of a memory to be accessed.

A typical example of selection of a memory to be accessed is that it is determined based on the access restriction information, such as a dirty bit or a read/write bit, and the access frequency information 20, whether data is to be written at a high frequency of writing and, if so, the data is written in a memory of high write speed or of small power consumption in writing.

In more specifically, it is supposed that the data cache of the L2-cache 7 has MRAMs and SRAMs. In this case, since the SRAMs are higher than the MRAMs in write speed, data which are to be written at a high frequency of writing are written, not in the MRAMs, but in the SRAMs. Therefore, it is possible to improve the write efficiency of the processor 2.

The access frequency information 20 included in the page entry information 11 of the TLB 4 or the page table 5 may be access frequency information 20 on the memories of all layers (the L1-cache 6, the L2-cache 7 and the main memory 10). Or it may be access frequency information 20 on a memory of a specific layer (for example, the L2-cache 7).

When acquiring the access frequency information 20 on the memories of all layers, as shown in the block diagram of FIG. 1, the MMU 3 acquires all access requests issued by the processor 2 and updates the access frequency information 20 per page using the above-described saturation counter or the like.

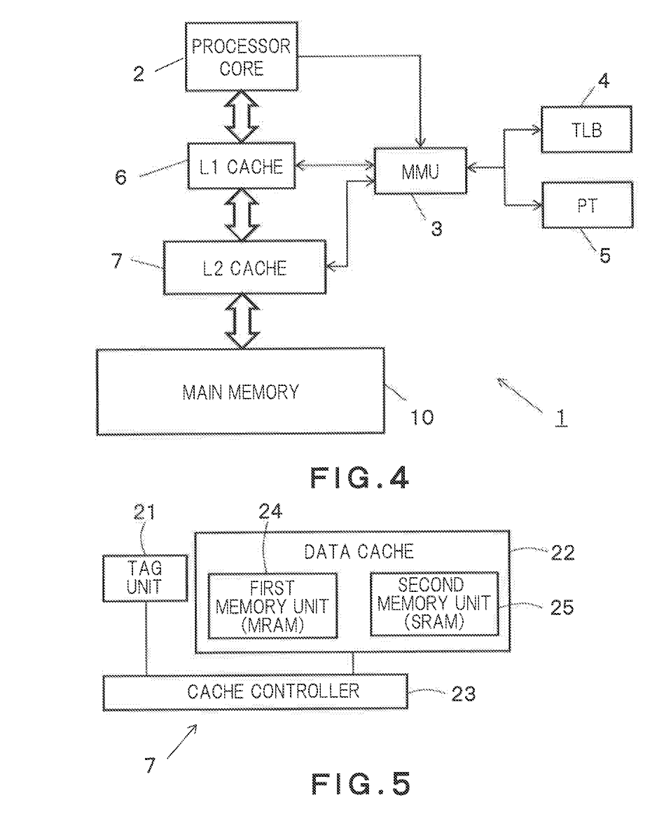

When acquiring the access frequency information 20 on a memory of a specific layer, the processor system 1 is configured as shown in a block diagram of FIG. 4, for example. In the case of FIG, 4, address information, at which writing and reading have been performed, is informed to the MMU 3 from the L2-cache 7 for which the access frequency information 20 is to be acquired. When the MMU 3 receives the information, the built-in saturation counter performs a count operation to update the access frequency information 20.

As described above, in the present embodiment, a memory to be accessed is selected based on the access restriction information, such as a dirty bit or a read/write bit, and/or the access frequency information 20. There are two types of groups of memories from which a memory to be accessed is selected. One type of group of memories has a plurality of memories having different characteristic arranged in parallel in one and the same layer (a group of memories in this case is referred to as a same-layer hybrid cache, hereinafter). The other type of group of memories has a plurality of memories having different characteristic arranged in different cache layers (a group of memories in this case is referred to as a different-layer hybrid cache, hereinafter).

(Same-Layer Hybrid Cache)

FIG. 5 is a block diagram showing an example of the same-layer hybrid cache. A cache memory of FIG. 5 is, for example, the L2-cache 7. The L2-cache 7 of FIG, 5 has a tag unit 21 to store address information, a data cache 22 to store data, and a cache controller 23. The data cache 22 has a first memory unit 24 of MRAMs and a second memory unit 25 of SRAMs. The first memory unit 24 is lower than the second memory unit 25 in write speed but smaller in cell area. Therefore, the first memory unit 24 has a larger memory capacity than the second memory unit 25.

The MMU 3 selects either the first memory unit 24 or the second memory unit 25 to access based on the access restriction information and/or the access frequency information 20. Then, the MMU 3 informs select information as a result of the selection to the cache controller 23 of the L2-cache 7 via the L1-cache 6. The cache controller 23 accesses either the first memory unit 24 or the second memory unit 25 according the information from the MMU 3. In more specifically, the cache controller 23 stores data to be written at a high frequency of writing in the second memory unit 25 of SRAMs so as to reduce the number of times of writing as much as possible to the first memory unit 24 of MRAMs. Data which is to be written not so often is stored in the first memory unit 24 having a larger memory capacity. These operations are referred to as memory access control.

There is a variety of forms of information from the MMU 3. For example, a 1-bit flag may be used to indicate whether writing or reading is performed more often. For example, the access restriction information and/or the access frequency information 20 of the MMU 3 may be sent to the L2-cache 7, as it is. For example, the MMU 3 may determine whether to access the SRAMs or MRAMs according to the access restriction information and/or the access frequency information 20 and send information on the determination to the L2-cache 7. In other words, the MMU 3 or the cache controller 23 may determine whether to access the SRAMs or MRAMs according to the access restriction information and/or the access frequency information 20 of the MMU 3.

In the same-layer hybrid cache, the access restriction information and the access frequency information 20 are used in a variety of ways.

An example shown first is to store R/W information as the access restriction information and/or the access frequency information 20. For example, when a write attribute has been set with a read/write bit, the R/W information is stored in the SRAMs, if not, in the MRAMs. For example, when a write attribute has been set with a read/write bit, with a dirty bit set, the R/W information is stored in the SRAMs, the other data in the MRAMs. For example, when a saturation counter is used to set +1 in the case of writing and −1 in the case of reading, as the access frequency information 20, data for which the count value is five or more is written in the SRAMs, the other data in the MRAMs. For example, when a write attribute has been set with a read/write bit, data for which the count value of the saturation counter for the access frequency information 20 is five or more is written in the SRAMs, the other data in the MRAMs.

An example shown next is to store cache hit/miss information as the access restriction information and/or the access frequency information 20. For example, when a saturation counter is used to set +1 in the case of cache miss and −1 in the case of cache hit, data for which the count value is three or more may be stored in the SRAMs, the other data in the MRAMs.

The above count values of the saturation counter are just an example. The value of the saturation counter as a threshold value may be 1, 10, etc. The threshold value may be dynamically changed in operation.

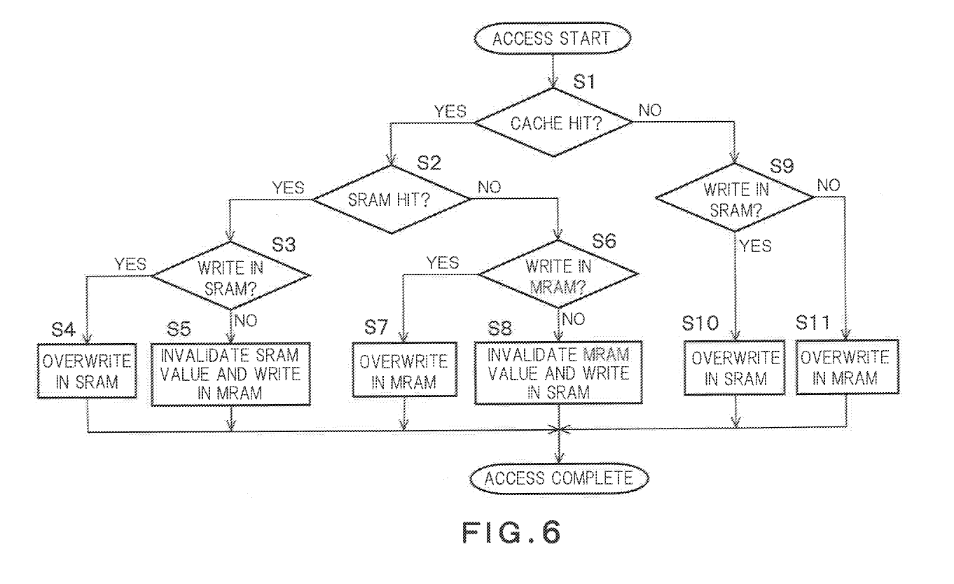

In the present embodiment, when the selection of destination for writing based on the access frequency information 20 is performed, the memory to be written may change depending on the condition of a program in running. Therefore, control is required in writing to maintain data consistency. The cache controller 23 is required to check whether data is present in a memory other than the memory to be written. If the data is present, a process to maintain data consistency is required. For example, as shown in FIG. 6, there is a method of invalidating data if present in a memory other than a memory to be written and then writing the data in the memory to be written.

FIG. 6 is a flow chart showing an example of a write process in the same-layer hybrid cache. The write process of FIG, 6 is an example in which the cache controller 23 of the L2-cache 7 has acquired all information. The write process of FIG. 6 is a process of data writing to the data cache 22 by the cache controller 23 of the L2-cache 7 in accordance with a write request from the L1-cache 6.

Firstly, it is determined whether there is a cache hit at a access-requested address (Step S1). If it is determined that there is a cache hit, it is determined whether there is a cache hit in the SRAMs of the first memory unit 24 (Step S2).

If it is determined that there is a cache hit in the SRAMs, it is determined whether to write data in the SRAMs (Step S3). If it is determined to write data in the SRAMs, the corresponding data in the SRAMs is overwritten with the above data (Step S4). If it is determined not to write the data in the SRAMs, the corresponding data in the SRAMs is invalidated and data for which there is a write request from the L1-cache 6 is written in the MRAMs of the first memory unit 24 (Step S5).

If it is determined in Step S2 that there is no cache hit in the SRAMs, it is determined whether to write data in the MRAMs of the first memory unit 24 (Step S6). If it is determined to write the data in the MRAMs, the corresponding data in the MRAMs is overwritten with the above data (Step S7). If it is determined not to write the data in the MRAMs, the corresponding data in the MRAMs is invalidated and data for which there is a write request from the L1-cache 6 is written in the SRAMs of the second memory unit 25 (Step S8).

If it is determined in Step S1 that there is no cache hit, it is determined whether to write the data in the SRAMs of the second memory unit 25 (Step S9). If it is determined to write the data in the SRAMs, the data is written in the SRAMs (Step S10). If it is determined not to write the data in the SRAMs, the data is written in the MRAMs (Step S11).

Instead of or together with the L2-cache 7, the L1-cache 6 may also have a plurality of memory units having different characteristics such as shown in FIG. 5.

(Different-Layer Hybrid Cache)

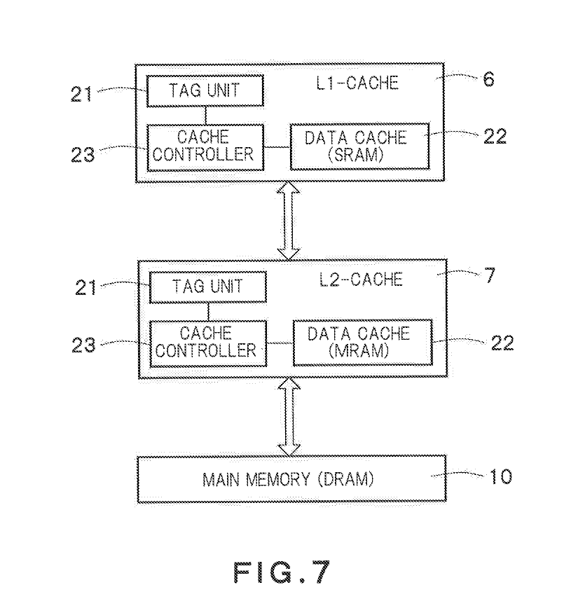

FIG. 7 is a block diagram showing an example of a different-layer hybrid cache, FIG. 7 shows an example in which the L1-cache 6, the L2-cache 7, and the main memory 10 have SRAMs, MRAMs, and DRAMs, respectively.

In the case of FIG. 7, data (high-priority data), for which the MMU 3 determines that the data is to be written at a high frequency of writing, is written in the L1-cache 6 as much as possible to reduce the number of write times to the L2-cache 7 having the MRAMs. As a method of storing data in the L1-cache 6 as much as possible, for example, there is a method using LRU (Least Recently Used) information. Another method is such that, for example, high-priority data only are allocated as MRU (Most Recently Used) data to a way assigned a small number, with other data not being treated as the MRU data even if the other data are accessed, so that the other data cannot be allocated to a way assigned a smaller number than the number of a way to which the high-priority data are allocated.

Still another method is such that data which are to be written at a high frequency of writing but not so reusable (which seem to be rarely read thereafter) are stored in the main memory 10 having the DRAMs as much as possible to reduce the number of write times to the L2-cache 7 having the MRAMs (bypass control). The bypass control may also be performed to data which are to be written at a low frequency of writing and not so reusable.

There is a variety of forms of information from the MMU 3. For example, a 1-bit flag may be used to indicate whether there are many cache misses or cache hits. For example, the access restriction information and/or the access frequency information 20 of the MMU 3 may be sent to the L2-cache 7, as it is. For example, the information may indicate whether to perform the bypass control. In other words, it may the MMU 3 or the cache controller 23 to determine whether to perform the bypass control according to the access restriction information and/or the access frequency information 20 of the MMU 3.

In the different-layer hybrid cache, the access restriction information and the access frequency information 20 are used in a variety of ways.

An example shown first is to store R/W information as the access restriction information and/or the access frequency information 20. For example, when a write attribute has been set with a read/write bit, the bypass control is performed, if not, the R/W information is stored in the L2-cache 7. For example, when a write attribute has been set with a read/write bit, with a dirty bit set, the bypass control is performed, with the other data being written in the L2-cache. For example, when a saturation counter is used to set +1 in the case of writing and −1 in the case of reading, as the access frequency information 20, the bypass control is performed for data for which the count value is five or more, the other data being written in the L2-cache 7. For example, when a write attribute has been set with a read/write bit, the bypass control is performed for data for which the count value of the saturation counter for the access frequency information 20 is five or more, the other data being written in the L2-cache 7.

An example shown next is to store cache hit/miss information as the access frequency information 20. For example, when a saturation counter is used to set +1 in the case of cache miss and −1 in the case of cache hit, the bypass control is performed for data for which the count value is three or more, the other data being written in the L2-cache 7.

The above count values of the saturation counter are just an example. The value of the saturation counter as a threshold value may be 1, 10, etc. The threshold value may be dynamically changed in operation,

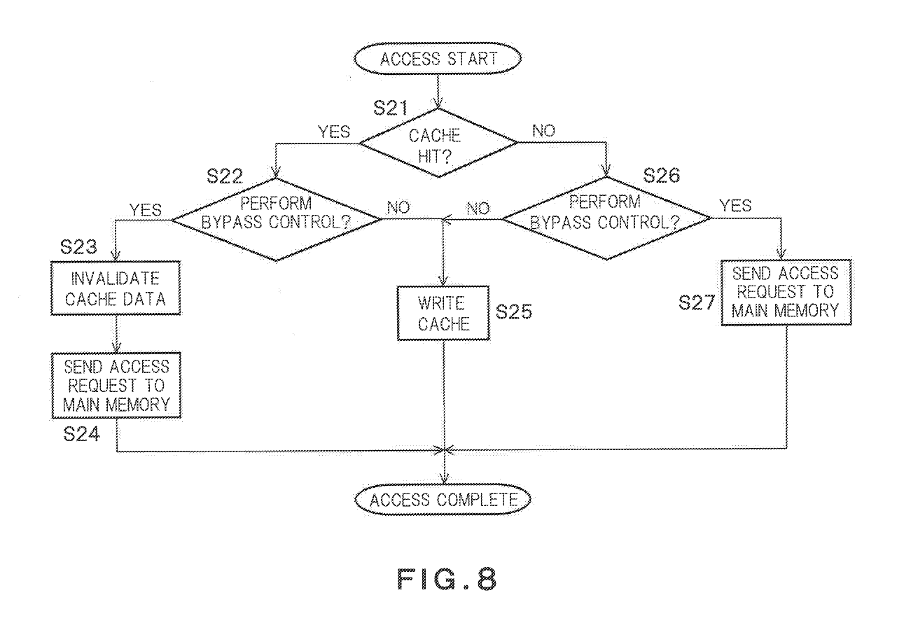

In the present embodiment, when the bypass control based on the access frequency information 20 is performed, the determination on the bypass control may change depending on the condition of a program in running. Therefore, the bypass control requires control to maintain data consistency. The cache controller 23 is required to check whether data is present in a cache (the L2-cache 7) for which the bypass control is to be performed. If data is present, a process to maintain data consistency is required. For example, as shown in FIG. 8, there is a method of invalidating data if present in the cache and performing the bypass control.

FIG. 8 is a flow chart showing an example of a write process in the different-layer hybrid cache. The write process of FIG. 8 is an example in which the cache controller 23 of the L2-cache 7 has acquired all information. The write process of FIG. 8 is a process of data writing to the data cache 22 by the cache controller 23 of the L2-cache 7 in accordance with an access request from the L1-cache 6.

Firstly, it is determined whether there is a cache hit at a access-requested address (Step S21). If it is determined that there is a cache hit, it is determined whether to perform the bypass control (Step S22). If performing the bypass control, data in the L2-cache 7 is invalidated (Step S23) and the access request is sent to the main memory 10 (Step S24). If it is determined in Step S22 not to perform the bypass control, data is written in the data cache 22 (Step S25). If it is determined in Step S21 that there is no cache hit, it is determined whether to perform the bypass control (Step S26). If performing the bypass control, the access request is sent to the main memory 10 (Step S27). If it is determined in Step S26 not to perform the bypass control, the data is written in the data cache 22 (Step S25).

There is a variety of methods of transferring information from the MMU 3 to the cache controller 23 in both of the same-layer hybrid cache and the different-layer hybrid cache. For example, together with address information sent from the MMU 3, the above-mentioned information may be sent to the L2-cache 7 via the L1-cache 6. For example, not together with the address information, information on cache control may be sent to the L2-cache 7 from the MMU 3.

In the case of transferring the information on cache control from the MMU 3 to the L2-cache 7, there is a variety of control procedures in use of the information of the MMU 3 in control. For example, it is supposed that the L1-cache 6 is a write back cache, so that write back is performed in flushing out data from the L1-cache 6 to the L2-cache 7.

In this case, the following procedure may, for example, be performed. For example, the L1-cache 6 sends a data address and data to the L2-cache 7, and also sends a request to the MMU 3 for sending information on target data to the L2-cache 7. On receiving the request, the MMU 3 sends the information to the L2-cache 7. The L2-cache 7 receives the information from the L1-cache 6 and also the information from the MMU 3 to perform the memory access control or the bypass control.

Moreover, for example, the L1-cache 6 sends a request to the MMU 3 for sending the information on target data to the L1-cache 6. On receiving the information from the MMU 3, the L1-cache 6 may send the received information to the L2-cache 7, together with the data address. The L2-cache 7 performs the memory access control or the bypass control, based on the information and the data address.

Furthermore, for example, the L2-cache 7, which has received the data address from the L1-cache 6, sends a request for information to the MMU 3. On receiving the information from the MMU 3, the L2-cache 7 performs the memory access control or the bypass control based on the information and the data address.

(Modification of Method of Storing Access Restriction Information and Access Frequency Information 20)

In the embodiment described above, the TLB 4 is a 1-layer page entry cache, for Simplicity. However, the present embodiment is applicable to the TLB 4 of plural layers. In the case, the simplest configuration is that the access restriction information and/or the access frequency information 20 are stored in all layers. However, the access restriction information and the access frequency information 20 may be stored in a part of layers. For example, the access restriction information and the access frequency information 20 are stored only in the lowest-layer TLB 4. With such a method, access to the TLB 4 can be physically distributed to different memories to reduce delay due to access collision to the TLB 4. A typical example which gives this effect is as follows. It is supposed that the CPU 2 looks up to the TLB 4 for the following two purposes at the same timing. One is to look up to the TLB 4 for memory access. The other is to look up to the TLB 4 for updating the access restriction information and the access frequency information 20 both in the L2-cache 7. In this case, access collision can be avoided by looking up to an upper-layer TLB 4 for the memory access and to a lower-layer TLB 4 for the updating.

(Modification of Form of Access Restriction Information and Access Frequency Information 20)

In the embodiment described above, the access restriction information and the access frequency information 20 are stored in pages, which may, however, be stored in cache lines. For example, if one page has four kilobytes, with 64-bytes for each line, 64 pieces of access restriction information and access frequency information 20 are stored in a page entry.

As described above, in the present embodiment, at least one of the access restriction information and the access frequency information 20 is stored in the TLB 4 and/or the page table 5. Based on the information, a memory which is most appropriate for access can be selected. Therefore, data to be written at a high frequency of writing can be written in a memory of high write speed or of small power consumption in writing, which improves the processing efficiency of the processor 2 and reduces power consumption. Therefore, the processing efficiency of the processor 2 is not lowered even if MRAMs, which are written at a low write speed and consume large power, are used for cache memories.

In the embodiment described above, the SRAMs, MRAMs and DRAMs are used for a plurality of memories of different characteristics. However, the memory types are not be limited to those. Other usable memory types are, for example, other types of non-volatile memory (for example, ReRAM (Resistance RAM) memory cells, PRAMS (Phase Change RAM), FRAMs (Ferroelectric RAM, a registered trademark), NAND flash memory cells, etc.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A cache memory system comprising:
a group of layered memories comprising two or more memories having different characteristics;
an access information storage which stores address conversion information from a virtual address included in an access request of a processor, into a physical address, and stores at least one of information on access frequency or information on access restriction, for data to be accessed with an access request from the processor; and
a controller to select a specific memory from the group of layered memories and perform access control, based on at least one of the information on access frequency and the information on access restriction in the access information storage, for data to be accessed with an access request from the processor,
wherein the information on access restriction in the access information storage comprises at least one of read-only information, write-only information, readable and writable information, and dirty information indicating that write-back to a lower layer memory is not yet performed.

2. The cache memory system of claim 1, wherein the access information storage comprises a translation lookaside buffer.

3. The cache memory system of claim 2 further comprising a page table that stores the address conversion information stored in the translation lookaside buffer and stores at least one of the information on access frequency and the information on access restriction, for data to be accessed with an access request from the processor,

4. The cache memory system of claim 1, wherein the group of layered memories comprises two or more memories which are different in access speed,
wherein the controller selects any one of the two or more memories which are different in access speed and performs access control, based on at least one of the information on access frequency and the information on access restriction, for data to be accessed with an access request from the processor.

5. The cache memory system of claim 1, wherein the group of layered memories comprises two or more memories which are different in power consumption,
wherein the controller selects any one of the two or more memories which are different in power consumption and performs access control, based on at least one of the information on access frequency and the information on access restriction, for data to be accessed with an access request from the processor.

6. The cache memory system of claim 1, wherein the group of layered memories comprises a k-level cache memory and a main memory, where k is an integer of 1 to n, and n is an integer equal to or more than 1, the k-level cache memory comprising a cache memory of at least a first layer,
wherein the k-level cache memory and the main memory are different in characteristics, and
the controller selects either the k-level cache memory or the main memory and performs access control, based on at least one of the information on access frequency and the information on access restriction, for data to be accessed with an access request from the processor.

7. The cache memory system of claim 1, wherein the access information storage stores at least one of the information on access frequency and the information on access restriction, per page having a larger data amount than a cache line accessed with the cache memory included in the group of layered memories.

8. The cache memory system of claim 1, wherein the information on access frequency in the access information storage is information on frequency of writing.

9. The cache memory system of claim 1, wherein the information on access frequency in the access information storage is information that indicates whether a difference between write times and read times for data is equal to or larger than a predetermined threshold value.

10. The cache memory system of claim 1, wherein the information on access frequency in the access information storage is information on at least one of cache hit or cache miss.

11. The cache memory system of claim 10, wherein the information on access frequency in the access information storage is information that indicates whether a difference between cache hit times and cache miss times for data is equal to or larger than a predetermined threshold value.

12. The cache memory system of claim 1, wherein the information on access frequency in the access information storage is information on access frequency to the group of layered memories.

13. The cache memory system of claim 1, wherein the information on access frequency in the access information storage is information on access frequency to a specific memory of the group of layered memories,
wherein the controller selects either the specific memory or a main memory based on the information on access frequency in the access information storage.

14. A processor system comprising:
a processor;
a group of layered memories comprising two or more memories having different characteristic
an access information storage which stores address conversion information from a virtual address included in an access request of a processor, into a physical address, and stores at least one of information on access frequency or information on access restriction, for data to be accessed with an access request from the processor; and
a controller to select a specific memory from the group of layered memories and perform access control, based on at least one of the information on access frequency and the information on access restriction, for data to be accessed with an access request from the processor,
wherein the information on access restriction in the access information storage comprises at least one of read-only information, write-only information, readable and writable information, and dirty information indicating that write-back to a lower layer memory is not yet performed.

15. The processor system of claim 14, wherein the access information storage comprises a translation lookaside buffer.

16. The processor system of claim 15 further comprising a page table that stores the address conversion information stored in the translation lookaside buffer and stores at least one of the information on access frequency and the information on access restriction, for data to be accessed with an access request from the processor.

17. The processor system of claim 14, wherein the group of layered memories comprises two or more memories which are different in access speed,
wherein the controller selects any one of the two or more memories which are different in access speed and performs access control, based on at least one of the information on access frequency and the information on access restriction, for data to be accessed with an access request from the processor.

18. The processor system of claim 14, wherein the group of layered memories comprises two or more memories which are different in power consumption,
wherein the controller selects any one of the two or more memories which are different in power consumption and performs access control, based on at least one of the information on access frequency and the information on access restriction, for data to be accessed with an access request from the processor.

19. The processor system of claim 14, wherein the group of layered memories comprises a k-level cache memory and a main memory, where k is an integer of 1 to n, and n is an integer equal to or more than 1, the k-level cache memory comprising a cache memory of at least a first layer,
wherein the k-level cache memory and the main memory are different in characteristics, and
the controller selects either the k-level cache memory or the main memory and performs access control, based on at least one of the information on access frequency and the information on access restriction, for data to be accessed with an access request from the processor.

20. The processor system of claim 14, wherein the access information storage stores at least one of the information on access frequency and the information on access restriction, per page having a larger data amount than a cache line accessed with the cache memory included in the group of layered memories.
